(19) United States
(12) Patent Application Publication
(10) Pub. No.: US 2026/0339503 A1
(43) Pub. Date: Oct. 29, 2026

(54) System and method for the discovery of viable Bayesian models by subject matter experts

(71) Applicant: VERSES AI Inc., New Westminster (CA)

(72) Inventors: Alexander B. Kiefer, Arverne, NY (US); Quinn K. Madison, Milwaukee, WI (US); Kenneth Cooper Williams, Geneva, NY (US); Sylvain Pronovost, Montreal (CA); Jasmine Moore, Montreal (CA); Lori A. Pike, Murrysville, PA (US); Timothy E. Bellay, Dallas, TX (US); Mohammed Al-Kalby, Palatine, IL (US)

(21) Appl. No.: 19/660,789

(22) Filed: Apr. 28, 2026

Related U.S. Application Data
(60) Provisional application No. 63/795,510, filed on Apr. 27, 2025.

(51) Int. Cl. G06F 3/0486; G06N 3/047

(52) U.S. Cl. CPC G06F 3/0486; G06N 3/047

(57) ABSTRACT

In a method for accompanying subject matter experts in the discovery of viable Bayesian models, an interface system is used to allow subject matter experts to send data to a software engine, and have them receive feedback on the appropriateness of the structure of the data, and on the viability of Bayesian models drawn out of this data.

### FIELD OF INVENTION

### Artificial Intelligence Model Development

### BACKGROUND

Subject matter experts (SMEs) in the applied artificial intelligence (AI) industry, such as information workers, are responsible for managing the work of technical experts such as data and machine learning scientists. The role of a SME is to deliver an outcome with business value using AI techniques applied to a dataset for which the SME has domain expertise. This is necessary when applying AI methods requiring expert knowledge for the development of the AI model, as is often the case in Bayesian models. For instance, an SME with domain expertise in supply chain logistics may be asked to deliver a strategy to optimize a given supply chain, that takes into account existing data about the said supply chain. Because SMEs are not themselves data science or machine learning experts, they must appeal to technical experts at all stages, from the discovery of best model candidates in the early stage of model development, to the training and the deployment of the trained model. The over reliance on technical experts may be a waste of valuable resources, especially in the early stages of model development, where the technical problems to solve remain relatively simple, and much of the work is about discovering viable candidate models worth using for inference, replicating with fidelity the causal structure of the systems being modelled, from which the data has been generated, and that the Bayesian model will predict.

### SUMMARY

According to the invention, there is provided a system and method for accompanying Subject Matter Experts (SMEs) in the discovery of viable Bayesian models. In one embodiment of the present invention, the code for the claimed method is implemented as a class in the Python programming language and is made up of a load method that allows the SME to load structured data onto a software engine, a data feedback method that provides feedback to the user as to whether the data is structured in a suitable way, a model building method that allows the SME to use his domain expertise to build candidate Bayesian models, a train method that trains the Bayesian model to make it ready for inference, and an model feedback method that provides the SME with metrics to compare candidate models. Taken together, the methods of the invention function as aids to model building. The invention thus speeds up discovery and testing of specialized domain Bayesian models while minimizing development overhead.

### BRIEF DESCRIPTION OF THE DRAWINGS

FIG. 1 illustrates a block diagram of one embodiment of the invention;

FIG. 2 depicts one embodiment of a model editor for the invention;

### DETAILED DESCRIPTION

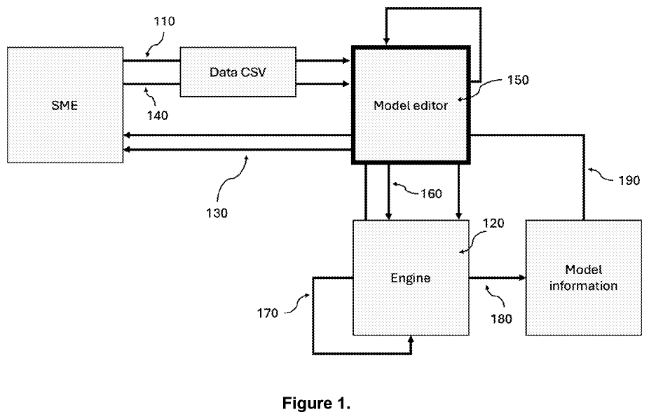

FIG. 1 illustrates a block diagram of one embodiment of the invention, wherein, in one embodiment of this invention, the Subject Matter Expert (SME) uploads structured Comma Separated Values (CSV) as input (110) via a model editor and onto a software engine (120). This constitutes the load method, and uses a computer program that takes the column names of the CSV file and uses them as variable names that the SME can use as nodes for a Bayesian network model such as known in the arts, and finds all of the unique elements in each column of the CSV file to determine the number of unique elements for each variable. The CSV must be structured by the SME by attributing each variable of interest in the dataset a column, and by attributing each variable element in a dataset a value that will be taken by the rows. Variables correspond to causally related events of interest, and elements correspond to characteristics of these events that the SME wants to predict with the Bayesian model. Each row of the CSV represents an occurrence of the events, with given characteristics. For instance, an event “A” with elements “a1” and “a2” may be known to cause an event “B” with elements “b1” and “b2”. One might have time series data over A and B, which could be used as input. The structured CSV would then be as follows:

| | A | B |
|---|---|---|
| t1 | a1 | b2 |
| t2 | a1 | b1 |
| t3 | a2 | b2 |
| . . . | | |
| tn | a1 | b1 |

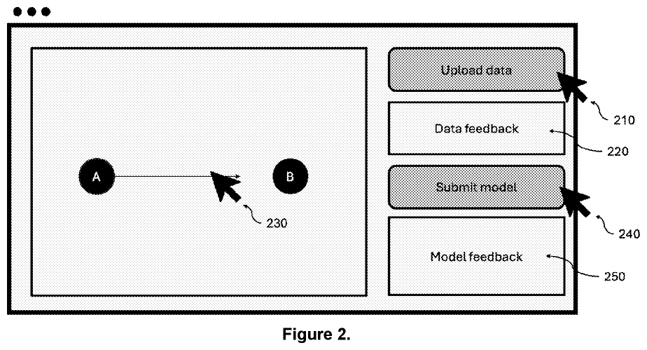

The software engine takes the CSV as input, and evaluates whether the CSV is correctly structured, using a computer program. In one embodiment of this invention, a criterion for evaluating the CSV may be the number of elements attributed to each variable. For instance, a maximum of 10 elements per variable may be allowed, and a maximum of 10 variables. These limits can be set as default, or adjusted by either the user (SME) or the deployer of the software engine. If the SME inputs a CSV with a variable with more than 10 elements, they will be presented via the model editor with a message requiring them to restructure the data to ensure that there are no more than 10 elements per variable as depicted by the feedback loop (130). This constitutes the data feedback method, and is achieved through computer programming using a feedback loop. After restructuring the CSV, the SME can upload it via the model editor (150). The SME can then build the model by connecting variables to one another using drag and pull and drag and drop actions via the model editor (150). The model editor displays the variable contained in the CSV onto the interface of the model editor. The SME, using their expert knowledge, in turn decides how to connect the variables so as to reflect the causal structure of the systems that produced the data. For instance, the expert may have uploaded weather data containing a weather variable “A” with, say, a “sunny” (a1) element and “cloudy” (a2) element, and a condition variable “B” containing, say, the elements “wet ground” (b1) and “dry ground” (b2). The expert may decide that “A” causes “B”, or may decide that “B” is in fact what causes “A”. This constitutes the model building method, and is achieved using an interface such as that defined in FIG. 2. The causal relationships represented by the arrows linking the variables constitute a Bayesian model. The SME can submit the model (160) for training (170) to the software engine 195. The software engine builds a Bayesian network out of the model drawn by the SME, using a computer program, as described below.

The software treats each variable from which an arrow departs as a source node, and the node that receives an arrow as destination node. The Bayesian network is thus formed of one or more source nodes, one or more destination nodes, and two types of factor nodes, wherein the first type of factor node correspond to the independent probability factors, or “priors”, for the elements in any source node that is not itself connected to another source node (e.g., P (A), if “A” is a source node), and wherein the second type of factor node corresponds to the conditional probabilities of the elements in a destination node in light of the elements of the source node, or “likelihood” (e.g., P(B|A) if “B” is a destination node a A is the source node). In one embodiment of this invention, the software engine builds the Bayesian network using the following sample pseudocode:

```
If A → B
  Prior = P(A)
  Likelihood = P(B|A)
elseif B → A
  Prior = P(B)
  Likelihood = P(A|B)
end
```

Using the CSV submitted by the SME, the software engine trains the Bayesian network. In one embodiment of this invention, the training is achieved using a method of count, where the factors of the network are treated as empirical priors that encode Dirichelet distributions that can be updated based on counts tracking the frequency of occurrence of elements in source nodes (i.e., priors) and the co-occurrence of elements in the relations between destination and source nodes (i.e., likelihood). The term co-occurrence defines the occurrence of a destination element and source element at the same time point according to the time series provided by the CSV file. Priors and likelihoods are encoded as vectors or matrices. For instance, if the CSV contains 6 occurrences of element a1, and 4 occurrences of the element a2, where the variable A is considered a source node that causes the variable B implemented as a destination node, then the software engine will attribute an independent probability of 0.6 to a1 (P(a1)=0.6) and an independent probability of 4 to a2 (P (a2)=0.4) as a result of adding 6 counts to a1 and 4 counts to a2 and normalizing the vector of counts for the prior in order to obtain a probability distribution summing to 1. The same method of count is used to train the likelihood parameters of the Bayesian network, where the occurrences used as counts are the co-occurrences of the elements mapped by the likelihood implemented as a matrix with columns representing elements of the source nodes, and rows representing elements of the destination nodes. For instance, if a row representing “t1” in the CSV contains “a1” under “A” and “b2” under B, then a count of +1 is added to the cell of the likelihood matrix corresponding to P (b1|a2). This constitutes the training method. Once the model is trained, the software engine can analyze the model to derive useful model information about the viability of the model to help the SME make a decision as to whether the model at hand is a good candidate model (180). The model information corresponds to (1) the magnitude of the parameter updates during training, computed as the Jensen-Shannon distance, as known in the art (Jianhua Lin. Divergence measures based on the Shannon entropy. IEEE Transactions on Information theory, 37(1): 145-151, 1991), per factor, between the model parameters before and after training, The Jensen-Shannon distance always lies in the interval [0, 1] and so is useful as a common metric across models. It provides the SME with information about training convergence, as parameter updates will tend toward 0 as the model converges. The model information is communicated back to the SME via the model editor interface to help the SME to reassess its candidate model (190). Both values are returned per model submitted, when training involves multiple iterations or epochs. FIG. 2 depicts one embodiment of a model editor for the invention. The SME uses the interface to upload data as depicted by the large cursor arrow 210, and receives feedback about whether the data structure is suitable via window 220 of the same interface. The SME can build a model by drawing the model with a cursor (230), and submit the model for analysis to the software engine as depicted by cursor 240. The software engine returns model information via the window 250 of the same interface, which can be used by the SME to assess his candidate model. For example, the feedback received in window 220 may concern the number of elements under each variable being too large, and the feedback received via window 250 may concern model information such as the Jensen-Shannon divergence between factors of the model.

What is claimed is:

1. An interface system enabling a subject matter expert (SME) to draw and evaluate Bayesian models, comprising,
an interface window capable of displaying the nodes and edges of a Bayesian network,
a Graphical User Interface (GUI) element in the form of a clickable button or region that enables the SME to upload a data file about source and destination entities to the software engine,
GUI elements in the form of connector lines or arrows that can be dragged and dropped or dragged and extended to connect the nodes of a Bayesian network, which defines the relationship between the source and destination entities listed in the data file,
a GUI element in the form of an information window that enables the SME to receive information feedback about the data file containing the source and destination entities,
a GUI element in the form of a clickable button or region that enables the SME to submit the drawn model structure with the connector lines to the software engine, and
a GUI element in the form of an information window that enables the SME to receive information feedback concerning the submitted model.

2. A method for providing a subject matter expert (SME) with actionable information concerning a proposed Bayesian model, comprising,
receiving data from an SME, wherein the data contains information about different variables and their elements, wherein the variables include source and destination node data with elements for each source and destination node,
providing feedback information to the SME if the data is not properly formatted, wherein the criterion for determining proper format includes, but is not limited to, the number of elements for the variable,
transforming the source and destination node variables into a Bayesian network, with source nodes, destinations nodes, and factor nodes, according a drawing connecting source nodes and destination nodes as performed by the SME using an interface window,
analysing the Bayesian network to obtain information about its viability by calculating the Jensen-Shannon distance between the probability distributions encoded in each factor node, and
providing model feedback information to the SME as to the viability of the proposed Bayesian model.
